(19) United States
(12) Patent Application Publication
(10) Pub. No.: US 2005/0077342 A1
(43) Pub. Date: Apr. 14, 2005

(54) Securing a cover for a device

(76) Inventors: Chien-Hua Chen, Corvallis, OR (US); David M Craig, Albany, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/683,910

(22) Filed: Oct. 10, 2003

(51) Int. Cl. B23K 35/12

(52) U.S. Cl. 228/254

(57) ABSTRACT

A cover is secured over a device supported by a substrate. A bond ring is formed on the cover, and an intermediate tacking layer is formed on top of the bond ring. The substrate is tacked to the tacking layer. The cover is then staked to the substrate.

### RELATED APPLICATION

This application is related to U.S. application entitled: “Bond Ring for Micro-electromechanical System” docket number 200308958-1, filed on the same date herewith, which is incorporated herein by reference.

### FIELD OF THE INVENTION

The present invention relates to devices, and in particular to securing a cover for the devices.

### BACKGROUND OF THE INVENTION

Micro-electromechanical system (MEMS) devices are very small and fragile. They need to be protected from physical harm and contamination. Some MEMS devices require a special environment, such as a gas or liquid fluid, in which to operate. Prior attempts to provide such protection involve the use of a cover, such as a window or plate fixed over the MEMS device to protect it. Such windows or plates may be fixed on an annular ring of a polymer extending above and around the MEMS device. Polymers may not be compatible with fluids required for proper operation of certain MEMS devices. Alternatives include the use of solder paste containing flux, which becomes a source of contamination for the MEMS device. It may be difficult to place and bond the window to the ring without damaging the MEMS device. Some materials require a high temperature to bond, or bond at lower temperatures with high forces that may adversely impact the MEMS device. A seal between the bond ring and the window may also need to be better than that obtained with polymer bond rings.

### BRIEF DESCRIPTION OF THE DRAWINGS

FIG. 1 is a partial side elevation representation of a cover for a micro-electromechanical system (MEMS) device with a cover bond ring according to an embodiment of the invention.

FIG. 2 is a partial side elevation representation of the cover bond ring of FIG. 1 with a mating substrate bond ring according to an embodiment of the invention.

FIG. 3 is a partial side elevation representation of tacking the cover bond ring of FIG. 1 to a mating substrate bond ring according to an embodiment of the invention.

FIG. 4 is a partial side elevation representation of an array of covers that are staked to an array of substrate bond rings surrounding MEMS devices according to an embodiment of the invention.

FIG. 5 is a partial side elevation representation of a MEMS device with a cover according to an embodiment of the invention.

FIG. 6 is a flowchart illustrating a process for attaching a cover bond ring to a mating substrate bond ring according to an embodiment of the invention.

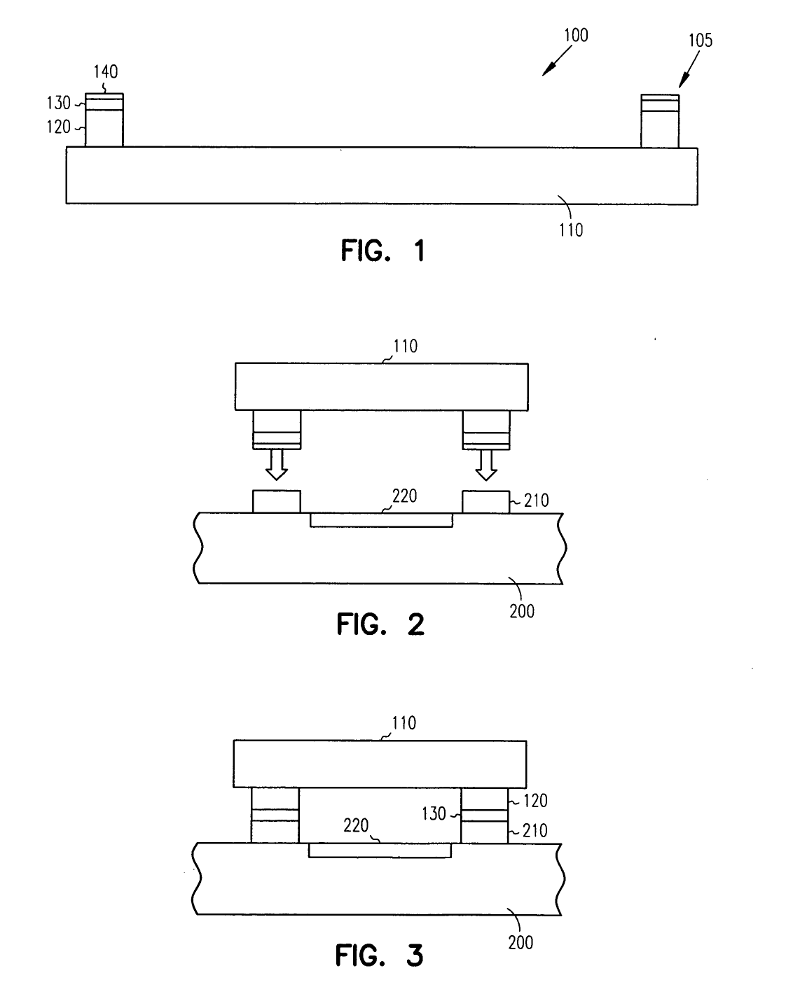

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

A cover 100 for a micro-electromechanical system (MEMS) device has an annular cover bond ring 105 formed thereon. In one embodiment, the cover comprises a window 110 formed of a transparent material such as glass. The window may be formed of different materials as desired or dictated by the type of MEMS device it is designed to protect. Some typical materials include silicon, gallium arsenide, sulfides and others. When an optical type MEMS device is to be protected, a transparent window is used. In other embodiments the window may be opaque, or formed of a material compatible with maintaining a hermetic seal over the MEMS device, or for maintaining a desired operating environment for the MEMS device, such as oil, gas such as argon or neon, or other types of fluid.

Cover bond ring 105 comprises a cover bond ring layer 120, an intermediate tacking layer 130, and optionally, a antioxidation layer 140, such as thin layer of noble metal covering the tacking layer 130 to prevent oxidation of the tacking layer 130. Other materials may be used for this purpose, but in one embodiment, Au is used.

The cover bond ring layer 120 is formed of an inorganic material such as gold, or a gold alloy in one embodiment, such as AuSn or AuGe. Sn containing solders, silver and copper and other materials may also be utilized. The intermediate tacking layer 130 comprises a thin layer of a soft low-melting point material such as In in one embodiment. Further materials include Bi, Sn or In and Bi alloys. In one example, the intermediate tacking layer 130 is between 100 A and 50 um thick. The cover bond ring 105 may also be formed in shapes other than annular, such as square, oval, or any other desired shape suitable for properly supporting the window and allowing full operation of the MEMS device. In one embodiment, the layers are deposited and patterned using lithographic processes, or other suitable processes. Depositing techniques include but are not limited to plating or vacuum deposition.

In further embodiments, the tacking layer 130 can be treated with argon sputtering, or a plasma treatment such as CHF3 or SF6 to activate the tacking layer 130.

FIG. 2 illustrates the cover being placed on substrate 200 containing a bond ring 210 surrounding a MEMS device 220. The bond ring 210 mates with the cover bond ring 105. The substrate 200 and cover 100 are heated to a temperature where the tacking layer becomes tacky. When the tacking layer 130 is formed of In, it is heated to approximately above 156° C., causing the In to melt and stick to the bond ring 210. In one embodiment, bond ring 210 is formed of a higher melting point solder, such as AuSn. In other words, the melting point of the bond ring 210 is higher than that of the tacking layer 130 to prevent it from melting during the tacking process. Other tacking temperatures may be utilized for different tacking materials. In is desired due to its low melting point and non-reactivity with other materials at such low temperatures. Such tacking allows for more precise placement of the cover 100 with respect to the bond ring 210, and also provides the ability to access exposed bond pads.

In an alternative embodiment, a tacking layer and optional antioxidant layer are formed on the bond ring 210 formed on substrate 200. In this embodiment, cover bond ring layer 130 need not have the tacking layer, or may also have a tacking layer if desired. In one embodiment, the bond ring 210 is formed of AuSn, tacking layer 130 is formed of Sn, and antioxidant layer 140 is formed of Ag.

FIG. 3 shows the cover tacked to the bond ring 210. The antioxidant layer 140 has basically disappeared in this view, and the cover is tacked, or adhered to the bond ring 210. The amount of adhesion at this point is sufficient for allowing further processing, such as making connections to bond pads outside the bond ring, but is not as strong as that desired for the final product. It need not provide a hermetic seal, but is sufficient given the low temperature and low stress required to form it.

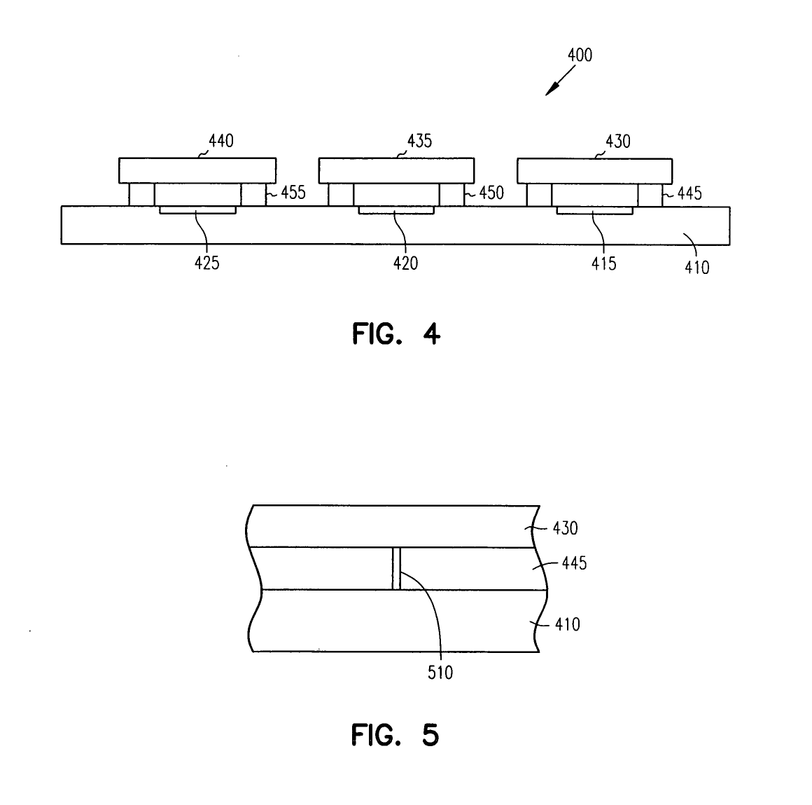

FIG. 4 shows an array of MEMS devices with covers at 400. The array is supported by silicon wafer or other material referred to as substrate 410, and comprises MEMS devices 415, 420 and 425. Each MEMS device is covered with respective covers 430, 435 and 440. FIG. 4 represents a continued process flow following the tacking of the covers as shown in FIG. 3. Further processing may also occur following tacking. After such processing, the substrate 410 with devices is heated to a higher temperature to stake the covers to the bond rings.

The tacking layer 130 is absorbed into the bond ring during the staking to form final bond rings 445, 450 and 455. The amount of In or other material used in tacking layer 130 is such that mechanical properties of the final bond rings 445, 450 and 455 are not adversely degraded. In one embodiment, the final bond rings comprises AuSn with a trace amount of In. The final bond rings may be between approximately 0.5 um to 60 um high in one embodiment. The actual height may be varied based on the type of MEMS device to be protected. Following staking, individual MEMS devices with covers may be saw cut from a wafer. Such individual MEMS devices are supported by cut sections of substrate 410.

FIG. 5 is a partial side elevation representation of a MEMS device with cover. Substrate 410 supports the bond ring 445 and cover 430. Additionally, a fill port 510 is shown cut out of the bond ring 445. The fill port may be formed in one or both the cover bond rings and substrate bond rings, and more than one may be provided. A fill port 510 may be used to fill the volume created around MEMS structures with a desired fluid. This may be done after tacking. The fill port 510 may also be used for fluid interconnections. The staking process may be used to close the fill port by melting the bond ring, optionally creating a hermetic seal.

In one embodiment, the bond rings on the substrate and the cover have a combined height to ensure that the cover has a sufficient height above the height of the MEMS structures, allowing such structures to operate properly when the cover is staked. The rings may be the same height, or one ring may be taller than the other. The bond rings may be formed by a process selected from the group consisting of physical vapor deposition, sputtering, evaporation, plating, or chemical vapor deposition.

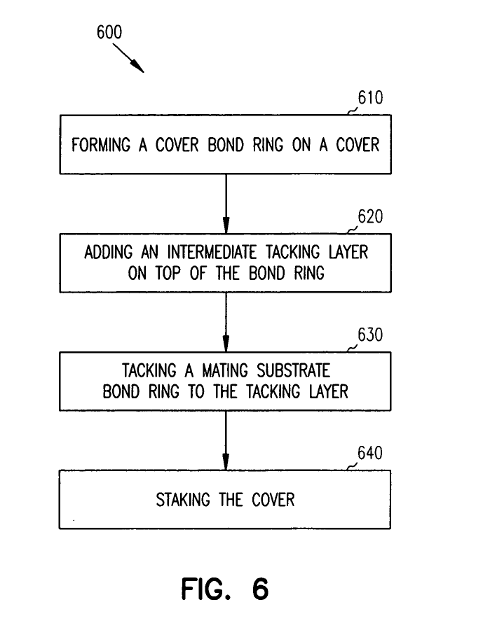

In one embodiment, the bond ring 210 on substrate 200 is formed by use of a method described in United States Application entitled: “Bond Ring for Micro-electromechanical System” docket number 200308958-1, filed on the same date herewith, which is incorporated herein by reference. At least one sacrificial layer is used to form a MEMS device. The sacrificial layer also serves to protect the MEMS device during deposition of bond ring material, which covers both a bond ring area, and the sacrificial layer. The bond ring material is formed to a desired depth in one of many ways compatible with the sacrificial layer. When the sacrificial layer is photoresist, the temperature of the process used to form the bond ring material is low enough to avoid burning the photoresist. The sacrificial layer is then etched, releasing the MEMS device. FIG. 6 is a flowchart illustrating a process 600 for attaching a cover bond ring to a mating substrate bond ring according to an embodiment of the invention. At 610 a cover bond ring is formed on a cover. An intermediate tacking layer is added on top of the bond ring at 620. An optional antioxidizing layer is added at this point. At 630 a mating substrate bond ring is tacked to the tacking layer, and at 640, the cover is staked.

1. A method of securing a cover over a device supported by a substrate, the method comprising:
forming a cover bond ring on the cover;
adding an intermediate tacking layer on top of the bond ring;
tacking a mating substrate bond ring to the tacking layer; and
staking the cover after tacking the mating substrate bond ring on the substrate to the tacking layer.

2. The method of claim 1 wherein the cover bond ring is inorganic.

3. The method of claim 2 wherein the cover bond ring comprises a high melting point solder.

4. The method of claim 2 wherein the cover bond ring comprises AuSn.

5. The method of claim 2 wherein the cover bond ring comprises Au.

6. The method of claim 1 wherein the intermediate layer comprises a low melting point material.

7. The method of claim 6 wherein the intermediate layer comprises In.

8. The method of claim 1 wherein tacking the cover is performed at low temperature and low pressure.

9. The method of claim 1 wherein staking the cover comprises reflowing the bond rings to form a permanent bond with the substrate.

10. The method of claim 1 wherein the cover is glass.

11. The method of claim 1 wherein tacking is performed at a temperature at or above a point where the tacking layer becomes tacky.

12. The method of claim 1 and further comprising forming an antioxidation layer over the intermediate layer.

13. The method of claim 12 wherein the antioxidation layer comprises a thin layer of noble metal.

14. The method of claim 1 wherein the device comprises a microelectromechanical device.

15. A method of securing a cover over a device supported by a substrate, the method comprising:
forming a bond ring on the cover;
adding an intermediate tacking layer on top of the bond ring;
tacking the substrate to the tacking layer; and
staking the cover after tacking the substrate.

16. A method of securing a glass cover over a device supported by a substrate, the method comprising:
forming a bond ring on the substrate surrounding the device;
forming a mating bond ring on the cover;
adding an intermediate In tacking layer on top of the bond ring;
covering the intermediate tacking layer with a noble metal;
tacking the bond ring on the substrate to the tacking layer; and
staking the cover by reflowing the bond ring to form a permanent bond with the substrate.

17. An article of manufacture comprising:
a device supported by a substrate;
a cover;
a bond ring formed on the cover, wherein the bond ring has a high melting point, and further having absorbed material with a lower melting point, wherein the cover and bond ring form a staked cover for the device.

18. The article of manufacture of claim 17, wherein the device comprises a microelectromechanical device.

19. The article of manufacture of claim 17 wherein the bond ring comprises AuSn.

20. The article of manufacture of claim 17 wherein the bond ring comprises a trace amount of In.

21. The article of manufacture of claim 17 wherein the bond ring comprises AuGe.

22. The article of manufacture of claim 17 wherein the bond ring comprises a Sn containing solder.

23. The article of manufacture of claim 17 wherein the cover comprises a window.

24. An article of manufacture comprising:
a cover for covering a microelectromechanical device;
a bond ring of inorganic material formed on the cover;
a tacking layer formed on top of the bond ring; and
an antioxidant layer formed on top of the tacking layer.

25. The article of manufacture of claim 24 wherein the tacking layer comprises In.

26. The article of manufacture of claim 24 wherein the antioxidant layer comprises a noble metal.

27. The article of manufacture of claim 26 wherein the antioxidant layer comprises Au.

28. The article of manufacture of claim 24 wherein the bond ring comprises AuSn.

29. The article of manufacture of claim 24 wherein the bond ring comprises AuGe.

30. The article of manufacture of claim 24 wherein the bond ring comprises a Sn containing solder.

31. The article of manufacture of claim 24 wherein the cover comprises a glass window.

32. A method of securing a cover over a device supported by a substrate, the method comprising:
forming a cover bond ring on the cover;
forming a mating substrate bond ring surrounding the device;
adding an intermediate tacking layer on top of on of the bond rings;
tacking the bond rings in a mated position; and
staking the cover after tacking the bond rings.

33. A method of securing a cover for a microelectromechanical device, the method comprising:
forming a bonding ring having a high melting point;
forming an intermediate layer on the bonding ring with a lower melting point;
tacking the intermediate layer over the microelectromechanical device at a low temperature and at low pressure; and
staking the cover over the microelectromechanical device at a higher temperature following the tacking at a higher temperature.

34. The method of claim 33 and further comprising forming a thin noble metal layer intermediate layer to prevent oxidation.

35. An article of manufacture comprising:
means for covering a microelectromechanical device;
a bond ring of inorganic material supported by the means for covering;
means for tacking the bond ring; and
means for preventing oxidation.
